(19) United States
(12) Patent Application Publication
(10) Pub. No.: US 2013/0203595 A1
(43) Pub. Date: Aug. 8, 2013

(54) STABLE MIXTURES AND RELATED METHODS

(71) Applicants: Jeffrey David Fowler, Greensboro, NC (US); Jason Leigh Vincent, Bracknell-Berkshire (GB)

(72) Inventors: Jeffrey David Fowler, Greensboro, NC (US); Jason Leigh Vincent, Bracknell-Berkshire (GB)

(73) Assignee: SYNGENTA CROP PROTECTION LLC, Greensboro, NC (US)

(21) Appl. No.: 13/511,914

(22) PCT Filed: Nov. 24, 2010
(86) PCT No.: PCT/US2010/057970

§ 371 Date: Feb. 4, 2013

(30) Foreign Application Priority Data
Nov. 24, 2009 (US) 61263845

(51) Int. Cl. A01N 25/22

(52) U.S. Cl. CPC A01N 25/22
USPC 504/117; 424/93.6; 424/405; 514/3.3; 530/350; 435/235.1

(57) ABSTRACT

Embodiments include a colloidal mixture comprising a liquid component and a solid component dispersed in the liquid component. The solid component comprises a plurality of fine-solid (FS) particles, and a plurality of phage particles having binding domains, or binding portions thereof, selected to bind to the plurality of FS particles. Embodiments also include methods or making colloids, method for improving the colloidal stability of a mixture, methods for inhibiting the growth of unwanted organisms, storage and shipping systems, and bio-additives.

### TECHNICAL FIELD

The present invention relates to colloidal mixtures having improved stability. More particularly, the invention relates to colloidal mixtures including fine-solid particles and phage particles or binding portions thereof. The invention also relates to methods of forming and using colloidal mixtures.

### BACKGROUND

Colloidal mixtures (also referred to herein as “colloids”) having a liquid component and a solid component may be used for a wide variety of reasons in a wide variety of arts. In agrochemical industries, for example, colloids may be used for the storage and delivery of herbicides, insecticides, fungicides, bactericides, fertilizers, etc. In other chemical industries, colloids may be used to formulate pharmaceuticals, dyes, inks, flavorings, etc.

Regardless of the industry, the ability to form stable colloids may attribute to efficacy or commercial success. Potential stability issues usually include at least one of sedimentation, serum formation, viscosity change, flocculation, and dilution difficulty. In the agrochemical industry, stability issues that affect the activity of an active ingredient or that affect the handling or application of a commercial product are particularly undesirable. Further, in the various arts, colloids may appear to be stable initially, but may have stability issues induced or increased by time, concentration, pH, temperature, etc.

### SUMMARY

The present invention is directed to numerous improvements in the colloidal arts. Examples include novel colloids, methods of making colloids, methods of using colloids, storage systems, and bio-additives for improving colloidal stability. Accordingly, these improvements may be realized in a variety of embodiments.

One exemplary embodiment includes a colloidal mixture comprising a liquid component and a solid component dispersed in the liquid component. The solid component comprises a plurality of fine-solid (FS) particles, and a plurality of phage particles having binding domains, or binding portions thereof, selected to bind to the plurality of FS particles.

Another exemplary embodiment includes a method for improving the colloidal stability of a mixture having a plurality of FS particles in a liquid component. In this embodiment, the method comprises admixing a plurality of phage particles or binding portions thereof with the liquid component. The plurality of phage particles or binding portions thereof have binding domains selected to bind to the plurality of FS particles. The phage particles are admixed at a concentration that improves the colloidal stability of the mixture.

Another exemplary embodiment includes a method for inhibiting the growth of an unwanted organism. The method includes administering a mixture of improved colloidal stability to a medium containing the unwanted organism. The mixture comprises a liquid component and a solid component dispersed in the liquid component. The solid component comprises a plurality of FS particles present in a biologically effective amount and a plurality of phage particles having binding domains, or binding portions thereof, selected to bind to the plurality of FS particles.

Another exemplary embodiment includes a storage and shipping system. The system includes a container having a capacity of about 0.1 L to about 160,000 L, and in additional embodiments from about 0.1 L to about 1000 L, and an aqueous mixture having improved colloidal stability located in the container. The aqueous mixture comprises about 0.1 to about 60 wt %, based on mixture weight, of a FS particle and about 0.01 to about 10 wt %, based on FS particle weight, of phage particles having binding domains, or binding portions thereof, selected to bind to the plurality of FS particles.

Another exemplary embodiment includes a bio-additive for improving the colloidal stability of an aqueous mixture comprising a plurality of FS particles. The bio-additive comprises a plurality of phage particles including a plurality of binding domains, or binding portions thereof, selected to bind to the active ingredient particles.

The above summary was intended to summarize certain exemplary embodiments of the present invention. Mixtures, methods, additives, etc. will be set forth in more detail, along with examples illustrating efficacy, in the figures and detailed description below. It will be apparent, however, that the detailed description is not intended to limit the present invention, the scope of which should be properly determined by the appended claims.

### BRIEF DESCRIPTION OF THE FIGURES

FIG. 1 illustrates dispersant functionality results from Example 3.

### DETAILED DESCRIPTION OF EXEMPLARY EMBODIMENTS

### Definitions

As used herein:

A colloidal material (also termed simply a “colloid”) includes fine-solid particles (also referred to herein as “FS particles”) in a liquid phase, wherein the properties of the material are dominated by inter-particle forces acting between the surfaces of adjacent particles. Exemplary inter-particle forces include electrostatic forces, van der Waals attractive forces, London dispersion forces, hydrophobic interactions, etc. FS particles diameters or dimensions may vary from embodiment to embodiment. Exemplary FS particles have diameters chosen from about 10 nanometer (nm) to about 100 micron (μm), in other examples, from about 100 nm to about 10 μm.

An “improvement in colloidal stability” is an improvement as measured by at least one of Colloidal Stability Assay I, Colloidal Stability Assay II, Colloidal Stability Assay III, and Colloidal Stability Assay IV.

### Colloidal Stability Assay I (Physical Stability Assay)

The fine-solid particles are dispersed in a liquid medium at a concentration convenient for packaging, transportation or sale. A sample of this liquid concentrate is placed in a glass container and stored either at a fixed temperature (which may be at, above or below ambient), or is subjected to temperature cycling from below ambient to either ambient or above. After a suitable interval the container is allowed to equilibrate to ambient temperature and the physical properties are compared with those before storage. The properties of interest include one or more of the following: viscosity as measured by a Brookfield rheometer or by a cup-and-bob or parallel plate type rheometer; the median particle size as measured by dynamic light scattering; the presence of any sediment may be determined by manual probe or visual examination; the presence of any serum may be determined by visual examination.

### Colloidal Stability Assay II (Rate of Sedimentation Assay)

The fine-solid particles are dispersed in a liquid medium at a concentration convenient for packaging, transportation or sale. A sample of this liquid concentrate is placed in a sample tube and subjected to centrifugation at a controlled temperature. The rate of serum or sediment formation is measured continuously either by visible light or X-ray transmittance or by visible light scattering.

### Colloidal Stability Assay III (Dilution Assay)

A concentrated sample of colloidal material is diluted in a liquid medium to a concentration suitable for application to control an unwanted organism. This diluted sample is placed in a glass measuring cylinder and inverted repeatedly until the liquid dispersion is homogeneous. The cylinder is left undisturbed and examined periodically over 1 hour to monitor any visible flocculation and the rates of serum and sediment formation. After 24 hours the cylinder is inverted repeatedly at about 0.5 Hz and the number of inversions needed to re-homogenize any sediment is recorded.

This test may be performed at ambient temperature or below. The liquid medium may be water of defined hardness, or a liquid fertilizer solution suitable for agriculture, or an organic solvent suitable for application. This test may also be performed on concentrated samples stored under conditions described above in the Physical Stability Assay as a further method to assess changes in colloidal dispersion.

### Colloidal Stability Assay IV (Flocculation Assay)

A concentrated sample of colloidal material is diluted in a liquid medium to a concentration suitable for application to control an unwanted organism. This diluted sample is observed under light microscopy to monitor any tendency of the colloidal particles to collect into flocculations. This behavior may be quantified by digital image analysis.

A “high binding affinity” means that after repeated wash cycles as described in example 2 below, the surface concentration of bound phage, or binding portions thereof, remains at least about 2.0×10¹³ pfu/m².

A “mid binding affinity” means that after repeated wash cycles as described in example 2 below, the surface concentration of bound phage, or binding portions thereof, is from about 2.0×10¹¹ pfu/m² to about 2.0×10¹³ pfu/m².

A “low binding affinity” means that after repeated wash cycles as described in example 2 below, the surface concentration of bound phage is from about 2.0×10⁹ pfu/m² to about 2.0×10¹¹ pfu/m².

The surface concentration of recovered phage may be determined by using 1 ul of each recovered sample to create a dilution series in LB: 1E3; 1E6; 1E9; 1E10; 1E11. 10 ul of each dilution is used to inoculate 200 ul of a host, e.g. ER2738 cells, (OD600=0.45) in 1.5 ml eppendorf tubes at room temperature for 5 mins. After this incubation, the contents of the inoculation tube are mixed with molten Top Agarose at 45 deg C. and immediately poured onto the surface of an LB plate. Once cooled, the plates are inverted and incubated at 37 deg C. overnight. Titre plates are inspected the following day.

The surface concentration of recovered phage particle “binding portions” may be determined by quantifying recovered binding portions based on a standard method for determining protein concentration such as the Bradford assay. Total protein concentration and the protein molecular weight can be used to determine the number of protein molecules per unit area of available surface. Phage particle “binding portions” are considered “plaque forming units” (pfus), regardless of their ability to form plaques, for determining concentration herein. For example, 1 binding portion peptide=1 pfu.

A “biologically effective amount” means an amount sufficient to either activate or inhibit a measurable process in a target organism. Such effects may be toxic or therapeutic depending on, for example, the embodiment.

“wt %” means wt/wt % unless indicated otherwise.

A “FS particle homolog” means a particle or component capable of eliciting at least the same level of biding affinity (i.e. low, mid or high) for an FS particle as the FS particle itself Exemplary FS particle homologs include FS particle complexes, particles having similar moieties, co-crystals, etc.

An “icosahedral morphology” means a viral capsid that is nearly-spherical or contains a capsid shell of identical repeating subunits. Phage exhibiting exemplary icosahedral morphologies include the family Leviviridae, Microviridae, Corticoviridae, Cystoviridae, and Tectiviridae.

A “complex morphology” means any viral capsid that is neither purely helical or purely icosahedral and possibly possess extra structures such as protein tails or complex outer walls. Phage exhibiting exemplary complex morphologies include the family Myoviridae, Podoviridea, Siphoviridae, and Plasmaviridae.

A “filamentous morphology” means a viral capsid stacked around a central axis forming a helical structure, often with a central cavity or hollow tube. Phage exhibiting exemplary filamentous morphologies include the family Inoviridae and Lipothrixviridae.

A “major coat protein” means a coat protein present in the highest copy number in a phage coat or capsid. An exemplary major coat protein of phage M13 includes P8. A “minor coat protein” includes coat proteins other than the major coat protein. Exemplary minor coat proteins of phage M13 include P3, P6, P7 and P9.

Phage particle “binding portions” or “binding portions thereof” include peptides comprising a binding domain selected to bind to an FS particle, wherein the binding domain may be fused to at least one stability-helper peptide. Stability-helper peptides in conjunction with the binding domain provide an improvement in colloidal stability as measured by at least one of Colloidal Stability Assay I, Colloidal Stability Assay II, Colloidal Stability Assay III, and Colloidal Stability Assay IV. Exemplary stability-helper peptides include at least one of phage M13's P8, P3, P6, P7 or P9 coat proteins, but the skilled practitioner will recognize that hydrophilic peptides in general will serve as stability-helper peptides according to, for example, the principle that polymeric dispersants comprise both hydrophobic domains that adsorb to FS particles and hydrophilic domains that remain solvated. In other embodiments, “binding portions” or “binding portions thereof” may include a peptide binding domain, such as an isolated peptide binding domain without a stability-helper peptide. Such binding domains may comprise the entire peptide or a portion thereof Such peptides may be hydrophobic, hydrophilic or amphiphilic.

An “excipient” includes rheology modifiers, biocides, electrolytes, humectants, solvents, polymers, adjuvants, conventional surfactants, conventional dispersants, freezing point depressants, dyes, pigments, emetics, alerting agents, bird-repellants, anti-counterfeiting agents, fragrances, odor-masking agents, anti-drift agents, weathering inhibitors, foaming and defoaming agents.

A “phage-display library” includes a collection of phage having DNA encoding peptide or protein variants ligated into at least one coat protein, e.g., the pIII or pVIII genes. The incorporation of many different DNA variants or fragments into the pIII or pVIII genes permits the generation a library from which members of interest can be selected and isolated. Commercially available phage-display libraries, for example, include Ph.D.-7, Ph.D.-12, and Ph.D.-C7C, available from New England Biolabs (Ipswich, Mass.). Phage-display libraries may be constructed as desired for use in accordance with the present invention.

As noted above, one embodiment includes a colloidal mixture comprising a liquid component and a solid component dispersed in the liquid component. The solid component comprises a plurality of fine-solid (FS) particles, and a plurality of phage particles having binding domains, or binding portions thereof, selected to bind to the plurality of FS particles. The liquid component may vary as needed, but will often include water.

The concentration of the solid component may vary within a wide range, for example, it may be chosen from about 0.1 to about 60 wt % of the mixture weight. Similarly, the concentration of the phage particles, or binding portions thereof, may vary within a mixture, with exemplary concentrations chosen from about 0.01 to about 10 wt % of the weight of the plurality of FS particles.

In many exemplary embodiments, the concentration of the phage particles, or binding portions thereof, will be sufficient to impart improved stability to the colloidal mixture. Measurement of this improvement can be determined by at least one assay chosen from Colloidal Stability Assay I, Colloidal Stability Assay II, Colloidal Stability Assay III, Colloidal Stability and Assay IV. Some may observe other improvements using other assays, and such mixtures are similarly within the scope of the instant invention.

The amount of improvement measured by the different assays may vary depending on, for example, the desired concentration of the solids. Improvements may include at least one of greater than 5%, greater than 10%, greater than 15%, greater than 20%, greater than 30%, and greater than 35% improvement. Still, some mixtures may achieve more or less improvement.

The FS particles chosen may vary from industry to industry. In the agrochemical industry, for example, the plurality of FS particles may include at least one of an acaricide, an algicide, an avicide, a bactericide, a fungicide, a herbicide, an insecticide, a molluscicide, a nematicide, a rodenticide, and a virucide. An insecticide such as thiamethoxam is exemplary. FS particles may be crystalline or polymorphic. Any of the following capable of forming solid particles in a liquid component may be suitable for FS particles according to the invention.

For example, at least one acaricide may be chosen from a antibiotic acaricide, such as nikkomycins and thuringiensin; a macrocyclic lactone acaricide, such as tetranactin; a avermectin acaricide, such as abamectin, doramectin, eprinomectin, ivermectin, and selamectin; a milbemycin acaricide, such as milbemectin, milbemycin, oxime, and moxidectin; a bridged diphenyl acaricide, such as azobenzene, benzoximate, benzyl benzoate, bromopropylate, chlorbenside, chlorfenethol, chlorfenson, chlorfensulphide, chlorobenzilate, chloropropylate, cyflumetofen, DDT, dicofol, diphenyl sulfone, dofenapyn, fenson, fentrifanil, fluorbenside, proclonol, tetradifon, and tetrasul; a carbamate acaricide, such as benomyl, carbanolate, carbaryl, carbofuran, methiocarb, metolcarb, promacyl, and propoxur; a oxime carbamate acaricide, such as aldicarb, butocarboxim, oxamyl, thiocarboxime, and thiofanox; a carbazate acaricide, such as bifenazate; a dinitrophenol acaricide, such as binapacryl, dinex, dinobuton, dinocap, dinocap-4, dinocap-6, dinocton, dinopenton, dinosulfon, dinoterbon, DNOC; a formamidine acaricide, such as amitraz, chlordimeform, chloromebuform, formetanate, and formparanate; a mite growth regulator, such as clofentezine, cyromazine, diflovidazin, dofenapyn, fluazuron, flubenzimine, flucycloxuron, flufenoxuron, and hexythiazox; an organochlorine acaricide, such as bromocyclen, camphechlor, DDT, dienochlor, endosulfan, and lindane; an organophosphorus acaricide; an organophosphate acaricide, such as chlorfenvinphos, crotoxyphos, dichlorvos, heptenophos, mevinphos, monocrotophos, naled, TEPP, and tetrachlorvinphos; an organothiophosphate acaricide, such as amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phoxim, pirimiphos-methyl, prothidathion, prothoate, pyrimitate, quinalphos, quintiofos, sophamide, sulfotep, thiometon, triazophos, trifenofos, and vamidothion; a phosphonate acaricide, such as trichlorfon; a phosphoramidothioate acaricide such as isocarbophos, methamidophos, and propetamphos; a phosphorodiamide acaricide, such as dimefox, mipafox, and schradan; an organotin acaricide, such as azocyclotin, cyhexatin, and fenbutatin oxide; a phenylsulfamide acaricide, such as dichlofluanid; a phthalimide acaricide, such as dialifos and phosmet; a pyrazole acaricide, such as cyenopyrafen, fenpyroximate, and tebufenpyrad; a phenylpyrazole acaricide, such as acetoprole, fipronil, and vaniliprole; a pyrethroid acaricide; a pyrethroid ester acaricide, such as acrinathrin, bifenthrin, cyhalothrin, cypermethrin, alpha-cypermethrin, fenpropathrin, fenvalerate, flucythrinate, flumethrin, fluvalinate, tau-fluvalinate, and permethrin; a pyrethroid ether acaricide, such as halfenprox; a pyrimidinamine acaricide such as pyrimidifen; a pyrrole acaricide, such as chlorfenapyr; a quinoxaline acaricide, such as chinomethionat and thioquinox; a sulfite ester acaricide, such as propargite; a tetronic acid acaricide, such as spirodiclofen; a tetrazine acaricide, such as clofentezine and diflovidazin; a thiazolidine acaricide, such as flubenzimine and hexythiazox; a thiocarbamate acaricide, such as fenothiocarb; a thiourea acaricide, such as chloromethiuron and diafenthiuron; and an unclassified acaricide, such as acequinocyl, amidoflumet, arsenous oxide, closantel, crotamiton, cymiazole, disulfiram, etoxazole, fenazaflor, fenazaquin, fluacrypyrim, fluenetil, mesulfen, MNAF, nifluridide, pyridaben, sulfiram, sulfluramid, sulfur, and triarathene.

At least one algicide may be may be chosen from a benzalkonium chloride, bethoxazin, copper sulfate, cybutryne, dichlone, dichlorophen, diuron, endothal, fentin, hydrated lime, isoproturon, methabenzthiazuron, nabam, oxyfluorfen, quinoclamine, quinonamid, simazine, and terbutryn.

At least one avicide may be chosen from 4-aminopyridine, chloralose, endrin, fenthion, and strychnine

At least one bactericide may be chosen from bronopol, copper hydroxide, cresol, dichlorophen, dipyrithione, dodicin, fenaminosulf, formaldehyde, hydrargaphen, 8-hydroxyquinoline sulfate, kasugamycin, nitrapyrin, octhilinone, oxolinic acid, oxytetracycline, probenazole, streptomycin, tecloftalam, and thiomersal.

At least one chemosterilants may be chosen from apholate, bisazir, busulfan, diflubenzuron, dimatif, hemel, hempa, metepa, methiotepa, methyl apholate, morzid, penfluron, tepa, thiohempa, thiotepa, tretamine, and uredepa.

At least one herbicide may may be chosen from an amide herbicide, such as allidochlor, amicarbazone, beflubutamid, benzadox, benzipram, bromobutide, cafenstrole, CDEA, cyprazole, dimethenamid, dimethenamid-P, diphenamid, epronaz, etnipromid, fentrazamide, flucarbazone, flupoxam, fomesafen, halosafen, isocarbamid, isoxaben, napropamide, naptalam, pethoxamid, propyzamide, quinonamid, saflufenacil, and tebutam; an anilide herbicide, such as chloranocryl, cisanilide, clomeprop, cypromid, diflufenican, etobenzanid, fenasulam, flufenacet, flufenican, ipfencarbazone, mefenacet, mefluidide, metamifop, monalide, naproanilide, pentanochlor, picolinafen, propanil, and sulfentrazone; an arylalanine herbicide, such as benzoylprop, flamprop, and flamprop-M; a chloroacetanilide herbicide, such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, and xylachlor; a sulfonanilide herbicide, such as benzofluor, cloransulam, diclosulam, florasulam, flumetsulam, metosulam, perfluidone, pyrimisulfan, and profluazol; a sulfonamide herbicide, such as asulam, carbasulam, fenasulam, oryzalin, penoxsulam, pyroxsulam; a thioamide herbicide, such as bencarbazone and chlorthiamid; an antibiotic herbicide, such as bilanafos; an aromatic acid herbicide; a benzoic acid herbicide, such as chloramben, dicamba, 2,3,6-TBA and tricamba; a pyrimidinyloxybenzoic acid herbicide, such as bispyribac and pyriminobac; a pyrimidinylthiobenzoic acid herbicide,such as pyrithiobac; a phthalic acid herbicide,such as chlorthal; a picolinic acid herbicide, such as aminopyralid, clopyralid, and picloram; a quinolinecarboxylic acid herbicide, such as quinclorac, and quinmerac; an arsenical herbicide, such as cacodylic acid, CMA, DSMA, hexaflurate, MAA, MAMA, MSMA, potassium arsenite, and sodium arsenite; a benzoylcyclohexanedione herbicide, such as mesotrione, sulcotrione, tefuryltrione, and tembotrione; a benzofuranyl alkylsulfonate herbicide, such as benfuresate and ethofumesate; a benzothiazole herbicide, such as benazolin, benzthiazuron, fenthiaprop, mefenacet, and methabenzthiazuron; a carbamate herbicide, such as asulam, carboxazole, chlorprocarb, dichlormate, fenasulam, karbutilate, and terbucarb; a carbanilate herbicide, such as barban, BCPC, carbasulam, carbetamide, CEPC, chlorbufam, chlorpropham, CPPC, desmedipham, phenisopham, phenmedipham, phenmedipham-ethyl, propham and swep; a cyclohexene oxime herbicide, such as alloxydim, butroxydim, clethodim, cloproxydim, cycloxydim, profoxydim, sethoxydim, tepraloxydim, and tralkoxydim; a cyclopropylisoxazole herbicide, such as isoxachlortole and isoxaflutole; a dicarboximide herbicide, such as cinidon-ethyl, flumezin, flumiclorac, flumioxazin, and flumipropyn; a dinitroaniline herbicide, such as benfluralin, butralin, dinitramine, ethalfluralin, fluchloralin, isopropalin, methalpropalin, nitralin, oryzalin, pendimethalin, prodiamine, profluralin, and trifluralin; a dinitrophenol herbicide, such as dinofenate, dinoprop, dinosam, dinoseb, dinoterb, DNOC, etinofen, and medinoterb; a diphenyl ether herbicide, such as ethoxyfen; a nitrophenyl ether herbicide, such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen, and oxyfluorfen; a dithiocarbamate herbicide, such as dazomet and metam; a halogenated aliphatic herbicide, such as alorac, chloropon, dalapon, flupropanate, hexachloroacetone, iodomethane, methyl bromide, monochloroacetic acid, SMA, and TCA; a imidazolinone herbicide, such as imazamethabenz, imazamox, imazapic, imazapyr, imazaquin, and imazethapyr; an inorganic herbicide, such as ammonium sulfamate, borax, calcium, hlorate, copper sulfate, ferrous sulfate, potassium azide, potassium cyanate, sodium azide, sodium chlorate, and sulfuric acid; a nitrile herbicide, such as bromobonil, bromoxynil, chloroxynil, dichlobenil, iodobonil, ioxynil, and pyraclonil; an organophosphorus herbicide, such as amiprofos-methyl, anilofos, bensulide, bilanafos, butamifos, 2,4-DEP, DMPA, EBEP, fosamine, glufosinate, glufosinate-P, glyphosate, and piperophos; an oxadiazolone herbicide, such as dimefuron, methazole, oxadiargyl, and oxadiazon; an oxazole herbicide, such as carboxazole, fenoxasulfone, isouron, isoxaben, isoxachlortole, isoxaflutole, monisouron, pyroxasulfone, and topramezone; a phenoxy herbicide, such as bromofenoxim, clomeprop, 2,4-DEB, 2,4-DEP, difenopenten, disul, erbon, etnipromid, fenteracol, and trifopsime; a phenoxyacetic herbicide, such as 4-CPA, 2,4-D, 3,4-DA, MCPA, MCPA-thioethyl, and 2,4,5-T; a phenoxybutyric herbicide, such as 4-CPB, 2,4-DB, 3,4-DB, MCPB, and 2,4,5-TB, a phenoxypropionic herbicide, such as cloprop, 4-CPP, dichlorprop, dichlorprop-P, 3,4-DP, fenoprop, mecoprop, and mecoprop-P; an aryloxyphenoxypropionic herbicide, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, and trifop; a phenylenediamine herbicide, such as dinitramine and prodiamine; a pyrazole herbicide, such as azimsulfuron, difenzoquat, halosulfuron, metazachlor, metazosulfuron, pyrazosulfuron, and pyroxasulfone; a benzoylpyrazole herbicide, such as benzofenap, pyrasulfotole, pyrazolynate, pyrazoxyfen, and topramezone; a phenylpyrazole herbicide, such as fluazolate, nipyraclofen, pinoxaden, and pyraflufen; a pyridazine herbicide, such as credazine, pyridafol, and pyridate; a pyridazinone herbicide, such as brompyrazon, chloridazon, dimidazon, flufenpyr, metflurazon, norflurazon, oxapyrazon, and pydanon; a pyridine herbicide, such as aminopyralid, cliodinate, clopyralid, diflufenican, dithiopyr, flufenican, fluroxypyr, haloxydine, picloram, picolinafen, pyriclor, pyroxsulam, thiazopyr, and triclopyr; a pyrimidinediamine herbicide, such as iprymidam and tioclorim, a quaternary ammonium herbicide, such as cyperquat, diethamquat, difenzoquat, diquat, morfamquat, and paraquat; a thiocarbamate herbicide, such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, and vernolate; a thiocarbonate herbicide, such as dimexano, EXD, and proxan; a thiourea herbicide, such as methiuron; a triazine herbicide, such as dipropetryn, indaziflam, triaziflam, and trihydroxytriazine; a chlorotriazine herbicide, such as atrazine, chlorazine, cyanazine, cyprazine, eglinazine, ipazine, mesoprazine, procyazine, proglinazine, propazine, sebuthylazine, simazine, terbuthylazine, and trietazine; a methoxytriazine herbicide, such as atraton, methometon, prometon, secbumeton, simeton, and terbumeton; a methylthiotriazine herbicide, such as ametryn, aziprotryne, cyanatryn, desmetryn, dimethametryn, methoprotryne, prometryn, simetryn, and terbutryn; a triazinone herbicide, such as ametridione, amibuzin, hexazinone, isomethiozin, metamitron and metribuzin; a triazole herbicide, such as amitrole, cafenstrole, epronaz, and flupoxam; a triazolone herbicide, such as amicarbazone, bencarbazone, carfentrazone, flucarbazone, ipfencarbazone, propoxycarbazone, sulfentrazone, and thiencarbazone; a triazolopyrimidine herbicide, such as cloransulam, diclosulam, florasulam, flumetsulam, metosulam, penoxsulam, and pyroxsulam; an uracil herbicide, such as benzfendizone, bromacil, butafenacil, flupropacil, isocil, lenacil, saflufenacil, and terbacil; an urea herbicide, such as benzthiazuron, cumyluron, cycluron, dichloralurea, diflufenzopyr, isonoruron, isouronaa, methabenzthiazuron, monisouron, noruron, a phenylurea herbicide, such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, and thidiazuron; a sulfonylurea herbicide; a pyrimidinylsulfonylurea herbicide, such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, nicosulfuron, orthosulfamuron, oxasulfuron, primisulfuron, propyrisulfuron, pyrazosulfuron, rimsulfuron, sulfometuron, sulfosulfuron, and trifloxysulfuron; a triazinylsulfonylurea herbicide, such as chlorsulfuron, cinosulfuron, ethametsulfuron, iodosulfuron, metsulfuron, prosulfuron, thifensulfuron, triasulfuron, tribenuron, triflusulfuron, and tritosulfuron; a thiadiazolylurea herbicide, such as buthiuron, ethidimuron, tebuthiuron, thiazafluron, and thidiazuron; and an unclassified herbicide, such as acrolein, allyl alcohol, aminocyclopyrachlor, azafenidin, bentazone, benzobicyclon, bicyclopyrone, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, endothal, fluoromidine, fluridone, flurochloridone, flurtamone, fluthiacet, indanofan, methyl isothiocyanate, OCH, oxaziclomefone, pentachlorophenol, pentoxazone, phenylmercury acetate, prosulfalin, pyribenzoxim, pyriftalid, quinoclamine, rhodethanil, sulglycapin, thidiazimin, tridiphane, trimeturon, tripropindan, and tritac.

At least one fungicide may be chosen from an aliphatic nitrogen fungicide, such as butylamine, cymoxanil, dodicin, dodine, guazatine, iminoctadine; an amide fungicide, such as carpropamid, chloraniformethan, cyflufenamid, diclocymet, ethaboxam, fenoxanil, flumetover, furametpyr, isopyrazam, mandipropamid, penthiopyrad, prochloraz, quinazamid, silthiofam, and triforine; an acylamino acid fungicide, such as benalaxyl, benalaxyl-M, furalaxyl, metalaxyl, metalaxyl-M, pefurazoate, and valifenalate; an anilide fungicide, such as benalaxyl, benalaxyl-M, bixafen, boscalid, carboxin, fenhexamid, isotianil, metalaxyl, metalaxyl-M, metsulfovax, ofurace, oxadixyl, oxycarboxin, penflufen, pyracarbolid, sedaxane, thifluzamide, and tiadinil; a benzanilide fungicide, such as benodanil, flutolanil, mebenil, mepronil, salicylanilide, and tecloftalam; a furanilide fungicide, such as fenfuram, furalaxyl, furcarbanil, and methfuroxam; a sulfonanilide fungicide, such as flusulfamide; a benzamide fungicide, such as benzohydroxamic acid, fluopicolide, fluopyram, tioxymid, trichlamide, zarilamid, and zoxamide; a furamide fungicide, such as cyclafuramid and furmecyclox; a phenylsulfamide fungicide, such as dichlofluanid and tolylfluanid; a sulfonamide fungicide, such as amisulbrom and cyazofamid; a valinamide fungicide, such as benthiavalicarb and iprovalicarb; an antibiotic fungicide, such as aureofungin, blasticidin-S, cycloheximide, griseofulvin, kasugamycin, natamycin, polyoxins, polyoxorim, streptomycin, and validamycin; a strobilurin fungicide, such as azoxystrobin, dimoxystrobin, fluoxastrobin, kresoxim-methyl, metominostrobin, orysastrobin, picoxystrobin, pyraclostrobin, pyrametostrobin, pyraoxystrobin, and trifloxystrobin; an aromatic fungicide, such as biphenyl, chlorodinitronaphthalene, chloroneb, chlorothalonil, cresol, dicloran, hexachlorobenzene, pentachlorophenol, quintozene, sodium pentachlorophenoxide, and tecnazene; a benzimidazole fungicide, such as benomyl, carbendazim, chlorfenazole, cypendazole, debacarb, fuberidazole, mecarbinzid, rabenzazole, and thiabendazole; a benzimidazole precursor fungicide, such as furophanate, thiophanate, and thiophanate-methyl; a benzothiazole fungicide, such as bentaluron, benthiavalicarb, chlobenthiazone, probenazole, and TCMTB; a bridged diphenyl fungicide, such as bithionol, dichlorophen, and diphenylamine; a carbamate fungicide, such as benthiavalicarb, furophanate, iprovalicarb, propamocarb, pyribencarb, thiophanate, and thiophanate-methyl; a benzimidazolylcarbamate fungicide, such as benomyl, carbendazim, cypendazole, debacarb, and mecarbinzid; a carbanilate fungicide, such as diethofencarb, pyraclostrobin, and pyrametostrobin; a conazole fungicide; a conazole fungicide (imidazoles), such as climbazole, clotrimazole, imazalil, oxpoconazole, prochloraz, triflumizole; a conazole fungicide (triazoles), such as azaconazole, bromuconazole, cyproconazole, diclobutrazol, difenoconazole, diniconazole diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P; a copper fungicide, such as Bordeaux mixture, Burgundy mixture, Cheshunt mixture, copper acetate, copper carbonate, basic, copper hydroxide, copper naphthenate, copper oleate, copper oxychloride, copper silicate, copper sulfate, copper sulfate, basic, copper zinc chromate, cufraneb, cuprobam, cuprous oxide, mancopper, and oxine-copper; a dicarboximide fungicide, such as famoxadone and fluoroimide; a dichlorophenyl dicarboximide fungicide, such as chlozolinate, dichlozoline, iprodione, isovaledione, myclozolin, procymidone, and vinclozolin; a phthalimide fungicide, such as captafol, captan, ditalimfos, folpet, and thiochlorfenphim; a dinitrophenol fungicide, such as binapacryl, dinobuton, dinocap, dinocap-4, dinocap-6, meptyldinocap, dinocton, dinopenton, dinosulfon, dinoterbon, and DNOC; a dithiocarbamate fungicide, such as azithiram, carbamorph, cufraneb, cuprobam, disulfiram, ferbam, metam, nabam, tecoram, thiram, and ziram; a cyclic dithiocarbamate fungicide, such as dazomet, etem, and milneb; a polymeric dithiocarbamate fungicide, such as mancopper, mancozeb, maneb, metiram, polycarbamate, propineb, and zineb; an imidazole fungicide, such as cyazofamid, fenamidone, fenapanil, glyodin, iprodione, isovaledione, pefurazoate, triazoxide; an inorganic fungicide, such as potassium azide, potassium thiocyanate, sodium azide, sulfur; a mercury fungicide; an inorganic mercury fungicide, such as mercuric chloride, mercuric oxide, and mercurous chloride; an organomercury fungicide, such as (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, and tolylmercury acetate; a morpholine fungicide, such as aldimorph, benzamorf, carbamorph, dimethomorph, dodemorph, fenpropimorph, flumorph, and tridemorph; an organophosphorus fungicide, such as ampropylfos, ditalimfos, edifenphos, fosetyl, hexylthiofos, iprobenfos, phosdiphen, pyrazophos, tolclofos-methyl, and triamiphos; an organotin fungicide, such as decafentin, fentin, and tributyltin oxide; an oxathiin fungicide, such as carboxin and oxycarboxin; an oxazole fungicide, such as chlozolinate, dichlozoline, drazoxolon, famoxadone, hymexazol, metazoxolon, myclozolin, oxadixyl, and vinclozolin; a polysulfide fungicide, such as barium polysulfide, calcium polysulfide, potassium polysulfide, and sodium polysulfide; a pyrazole fungicide, such as bixafen, furametpyr, isopyrazam, penflufen, penthiopyrad, pyraclostrobin, pyrametostrobin, pyraoxystrobin, rabenzazole, and sedaxane; a pyridine fungicide, such as boscalid, buthiobate, dipyrithione, fluazinam, fluopicolide, fluopyram, pyribencarb, pyridinitril, pyrifenox, pyroxychlor, and pyroxyfur; a pyrimidine fungicide, such as bupirimate, diflumetorim, dimethirimol, ethirimol, fenarimol, ferimzone, nuarimol, and triarimol; an anilinopyrimidine fungicide, such as cyprodinil, mepanipyrim, and pyrimethanil; a pyrrole fungicide, such as fenpiclonil, fludioxonil, and fluoroimide; a quinoline fungicide, such as ethoxyquin, halacrinate, 8-hydroxyquinoline sulfate, quinacetol, quinoxyfen, and tebufloquin; a quinone fungicide, such as benquinox, chloranil, dichlone, and dithianon; a quinoxaline fungicide, such as chinomethionat, chlorquinox, and thioquinox; a thiazole fungicide, such as ethaboxam, etridiazole, isotianil, metsulfovax, octhilinone, thiabendazole, and thifluzamide; a thiazolidine fungicide, such as flutianil and thiadifluor; a thiocarbamate fungicide, such as methasulfocarb and prothiocarb; a thiophene fungicide, such as ethaboxam and silthiofam; a triazine fungicide, such as anilazine; a triazole fungicide, such as amisulbrom, bitertanol, fluotrimazole, triazbutil; a triazolopyrimidine fungicide, such as ametoctradin; an urea fungicide, such as bentaluron, pencycuron, and quinazamid; and an unclassified fungicide, such as acibenzolar, acypetacs, allyl alcohol, benzalkonium chloride, benzamacril, bethoxazin, carvone, chloropicrin, DBCP, dehydroacetic acid, diclomezine, diethyl pyrocarbonate, fenaminosulf, fenitropan, fenpropidin, formaldehyde, furfural, hexachlorobutadiene, iodomethane, isoprothiolane, methyl bromide, methyl isothiocyanate, metrafenone, nitrostyrene, nitrothal-isopropyl, OCH, 2-phenylphenol, phthalide, piperalin, proquinazid, pyroquilon, sodium orthophenylphenoxide, spiroxamine, sultropen, thicyofen, tricyclazole, and zinc naphthenate.

At least one insecticide may be chosen from an antibiotic insecticide, such as allosamidin and thuringiensin; an acrocyclic lactone insecticide; an avermectin insecticide, such as abamectin, doramectin, emamectin, eprinomectin, ivermectin, and selamectin; a milbemycin insecticide, such as lepimectin, milbemectin, milbemycin oxime, and moxidectin; a spinosyn insecticide, such as spinetoram and spinosad; an arsenical insecticide, such as calcium arsenate, copper acetoarsenite, copper arsenate, lead arsenate, potassium arsenite, and sodium arsenite; a botanical insecticide, such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania, and sabadilla; a carbamate insecticide, such as bendiocarb and carbaryl; a benzofuranyl methylcarbamate insecticide, such as benfuracarb, carbofuran, carbosulfan, decarbofuran, and furathiocarb; a dimethylcarbamate insecticide, such as dimetan, dimetilan, hyquincarb, and pirimicarb; an oxime carbamate insecticide, such as alanycarb, aldicarb, aldoxycarb, butocarboxim, butoxycarboxim, methomyl, nitrilacarb, oxamyl, tazimcarb, thiocarboxime, thiodicarb, and thiofanox; a phenyl methylcarbamate insecticide, such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC, and xylylcarb; a desiccant insecticide, such as boric acid, diatomaceous earth, and silica gel; a diamide insecticide, such as chlorantraniliprole, cyantraniliprole, and flubendiamide; a dinitrophenol insecticide, such as dinex, dinoprop, dinosam, and DNOC; a fluorine insecticide, such as barium hexafluorosilicate, cryolite, sodium fluoride, sodium hexafluorosilicate, and sulfluramid; a formamidine insecticide, such as amitraz, chlordimeform, formetanate, and formparanate; a fumigant insecticide, such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride, and tetrachloroethane; an inorganic insecticide, such as borax, boric acid, calcium polysulfide, copper oleate, diatomaceous earth, mercurous chloride, potassium thiocyanate, silica gel, sodium thiocyanate; an insect growth regulator; a chitin synthesis inhibitor, such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, and triflumuron; a juvenile hormone mimic, such as epofenonane, fenoxycarb, hydroprene, kinoprene, methoprene, pyriproxyfen, and triprene; a juvenile hormone, such as juvenile hormone I, juvenile hormone II, and juvenile hormone III; a moulting hormone agonist, such as chromafenozide, halofenozide, methoxyfenozide, and tebufenozide; a moulting hormone, such as α-ecdysone and ecdysterone; a moulting inhibitor, such as diofenolan; a precocene, such as precocene I, precocene II, and precocene III; an unclassified insect growth regulator, such as dicyclanil; a nereistoxin analogue insecticide, such as bensultap, cartap, thiocyclam, and thiosultap; a nicotinoid insecticide, such as flonicamid; a nitroguanidine insecticide, such as clothianidin, dinotefuran, imidacloprid, and thiamethoxam; a nitromethylene insecticide, such as nitenpyram and nithiazine; a pyridylmethylamine insecticide, such as acetamiprid, imidacloprid, nitenpyram, and thiacloprid; an organochlorine insecticide, such as bromo-DDT, camphechlor, DDT, pp′-DDT, ethyl-DDD, HCH, gamma-HCH, lindane, methoxychlor, pentachlorophenol, and TDE; a cyclodiene insecticide, such as aldrin, bromocyclen, chlorbicyclen, chlordane, chlordecone, dieldrin, dilor, endosulfan, alpha-endosulfan, endrin, HEOD, heptachlor, HHDN, isobenzan, isodrin, kelevan, and mirex; an organophosphorus insecticide; an organophosphate insecticide, such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP, and tetrachlorvinphos; an organothiophosphate insecticide, such as dioxabenzofos, fosmethilan, and phenthoate; an aliphatic organothiophosphate insecticide, such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos, and thiometon; an aliphatic amide organothiophosphate insecticide, such as amidithion, cyanthoate, dimethoate, ethoate-methyl, formothion, mecarbam, omethoate, prothoate, sophamide, and vamidothion; an oxime organothiophosphate insecticide, such as chlorphoxim, phoxim, and phoxim-methyl; a heterocyclic organothiophosphate insecticide, such as azamethiphos, coumaphos, coumithoate, dioxathion, endothion, menazon, morphothion, phosalone, pyraclofos, pyridaphenthion, and quinothion; a benzothiopyran organothiophosphate insecticide, such as dithicrofos and thicrofos; a benzotriazine organothiophosphate insecticide, such as azinphos-ethyl and azinphos-methyl; an isoindole organothiophosphate insecticide, such as dialifos and phosmet; an isoxazole organothiophosphate insecticide, such as isoxathion and zolaprofos; a pyrazolopyrimidine organothiophosphate insecticide, such as chlorprazophos and pyrazophos; a pyridine organothiophosphate insecticide, such as chlorpyrifos and chlorpyrifos-methyl; a pyrimidine organothiophosphate insecticide, such as butathiofos, diazinon, etrimfos, lirimfos, pirimiphos-ethyl, pirimiphos-methyl, primidophos, pyrimitate, and tebupirimfos; a quinoxaline organothiophosphate insecticide, such as quinalphos and quinalphos-methyl; a thiadiazole organothiophosphate insecticide, such as athidathion, lythidathion, methidathion, and prothidathion; a triazole organothiophosphate insecticide, such as isazofos and triazophos; a phenyl organothiophosphate insecticide, such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion fenthion-ethyl, heterophos, jodfenphos, mesulfenfos, parathion, parathion-methyl, phenkapton, phosnichlor, profenofos, prothiofos, sulprofos, temephos, trichlormetaphos-3, and trifenofos; a phosphonate insecticide, such as butonate and trichlorfon; a phosphonothioate insecticide, such as mecarphon; a phenyl ethylphosphonothioate insecticide, such as fonofos and trichloronat; a phenyl phenylphosphonothioate insecticide,such as cyanofenphos, EPN, and leptophos; a phosphoramidate insecticide,such as crufomate, fenamiphos, fosthietan, mephosfolan, phosfolan, and pirimetaphos; a phosphoramidothioate insecticide,such as acephate, isocarbophos, isofenphos, isofenphos-methyl, methamidophos, and propetamphos; a phosphorodiamide insecticide,such as dimefox, mazidox, mipafox, and schradan; an oxadiazine insecticide,such as indoxacarb; an oxadiazolone insecticide,such as metoxadiazone; a phthalimide insecticide,such as dialifos, phosmet, and tetramethrin; a pyrazole insecticide,such as chlorantraniliprole, cyantraniliprole, dimetilan, tebufenpyrad, and tolfenpyrad; a penylpyrazole insecticide,such as acetoprole, ethiprole, fipronil, pyraclofos, pyrafluprole, pyriprole, and vaniliprole; a pyrethroid insecticide; a pyrethroid ester insecticide,such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, and transfluthrin; a pyrethroid ether insecticide, such as etofenprox, flufenprox, halfenprox, protrifenbute, and silafluofen; a pyrimidinamine insecticide, such as flufenerim and pyrimidifen; a pyrrole insecticide, such as chlorfenapyr; a tetramic acid insecticide, such as spirotetramat; a tetronic acid insecticide, such as spiromesifen; a thiazole insecticide, such as clothianidin and thiamethoxam; a thiazolidine insecticide, such as tazimcarb and thiacloprid; a thiourea insecticide, such as diafenthiuron; an urea insecticide, such as flucofuron, sulcofuron, and chitin synthesis inhibitors; and an unclassified insecticide, such as closantel, copper naphthenate, crotamiton, EXD, fenazaflor, fenoxacrim, hydramethylnon, isoprothiolane, malonoben, metaflumizone, nifluridide, plifenate, pyridaben, pyridalyl, pyrifluquinazon, rafoxanide, sulfoxaflor, triarathene, and triazamate.

At least one molluscicide may be chosen from a bromoacetamide, calcium arsenate, cloethocarb, copper acetoarsenite, copper sulfate, fentin, metaldehyde, methiocarb, niclosamide, pentachlorophenol, sodium pentachlorophenoxide, tazimcarb, thiacloprid, thiodicarb, tralopyril, tributyltin oxide, trifenmorph, and trimethacarb.

At least one nematicide may be chosen from an antibiotic nematicide, such as abamectin; a carbamate nematicide, such as benomyl, carbofuran, carbosulfan, and cloethocarb; an oxime carbamate nematicide, such as alanycarb, aldicarb, aldoxycarb, and oxamyl; an organophosphorus nematicide; an organophosphate nematicide, such as diamidafos, fenamiphos, fosthietan, and phosphamidon; an organothiophosphate nematicide, such as cadusafos, chlorpyrifos, dichlofenthion, dimethoate, ethoprophos, fensulfothion, fosthiazate, heterophos, isamidofos, isazofos, phorate, phosphocarb, terbufos, thionazin, and triazophos; a phosphonothioate nematicide, such as imicyafos and mecarphon; and an unclassified nematicide, such as acetoprole, benclothiaz, chloropicrin, dazomet, DBCP, DCIP, 1,2-dichloropropane, 1,3-dichloropropene, furfural, iodomethane, metam, methyl bromide, methyl isothiocyanate, and xylenols.

At least one rodenticide may be chosen from a botanical rodenticide, such as scilliroside and strychnine; a coumarin rodenticide, such as brodifacoum, bromadiolone, coumachlor, coumafuryl, coumatetralyl, difenacoum, difethialone, flocoumafen, and warfarin; an indandione rodenticide, such as chlorophacinone, diphacinone, and pindone; an inorganic rodenticide, such as arsenous oxide, phosphorus, potassium arsenite, sodium arsenite, thallium sulfate, and zinc phosphide; an organochlorine rodenticide, such as gamma-HCH, HCH, and lindane; an organophosphorus rodenticide, such as phosacetim; a pyrimidinamine rodenticide, such as crimidine; a thiourea rodenticide, such as antu; a urea rodenticide, such as pyrinuron; and an unclassified rodenticide, such as bromethalin, chloralose, α-chlorohydrin, ergocalciferol, fluoroacetamide, flupropadine, hydrogen cyanide, norbormide, and sodium fluoroacetate. At least one virucide may include ribavirin. This list is exemplary of course.

The size of the various FS particles may vary from embodiment to embodiment, depending on, for example, milling procedures employed. Exemplary FS particles have median diameter chosen from about 10⁻⁸ to about 10 ⁻⁴ m. Median diameter of particles in formulation may be estimated based on dynamic light scattering (DLS) theory. Suitable DLS detectors may be obtained from Malvern Instruments Ltd. having an office in Malvern, UK.

Phage particles having binding domains may also vary from mixture to mixture. For example, phage particles may include members of at least one morphological group chosen from icosahedral, complex and filamentous phage. The binding domains of the phage particles may similarly vary, but are often biologically-expressed as translational fusions with phage coat proteins. The length of binding domains and their binding affinity may vary from embodiment to embodiment. Exemplary binding domains will have lengths chosen from about 3 to about 20 or more amino acids and binding affinities chosen from at least one of low, mid and high. Exemplary phage particles include M13 phage having 7, 8, 9, 10, 11, 12, 13, 14 or 15 amino acid-long binding domains fused to their P3 coat protein, with the binding domains having at least a low level of binding affinity.

Suitable binding domains may be obtained using a phage-display library available from New England Biolabs (Ipswich, Mass.). In addition to using binding domains obtained by commercial phage-display libraries, numerous protein structural domains are capable of forming contacts with target surfaces to achieve affinity-interactions and may be used. Such protein structural domains include, for example, the following domains and fragments thereof: FAb; Fv; scFv; stAb; dAb; V_{HH}; IgNAR; CDRs; DARPin ankyrin-repeat proteins; anti-calins; antibody-mimics. The ability to form translational fusions is within the skill of a person in the art.

Still, binding domains for phage particles or binding portions thereof may be generated in other ways. By way of example, the crystal structure of an active ingredient may be determined experimentally by conventional X-ray scattering techniques and the faces of the external crystal planes modeled using simulation software. Polypeptides with high binding affinity to each of the exposed crystal faces may then identified, for example, by calculating the most energetically favored secondary and tertiary conformation of a given polypeptide in water, by calculating the orientation of this polypeptide to each crystal face that maximizes the binding energy between the polypeptide and crystal, and by allowing the polypeptide secondary and tertiary structures to flex to further maximize the binding energy. This or other algorithms may be repeatedly applied to polypeptides with different primary structures until a peptide of the desired binding affinity is identified. The polypeptide may be produced by expression in a convenient organism, in cell-free extracts, or by chemical synthesis as known in the art. By way of example, see Stephen B. H. Kent, Chemical Synthesis of Peptides and Proteins, Ann. Rev. Biochem., 57:957-89 (1988) or R. Bruce Merrifield, Solid Phase Peptide Synthesis. I The Synthesis of a Tetrapeptide, J. Am. Chem. Soc., 85:2149-54 (1963). Synthesized peptides may be used with phage particles or binding portions thereof.

In addition to colloidal mixtures, exemplary embodiments of the invention are also directed to various methods. Another exemplary embodiment, for example, includes a method for improving the colloidal stability of a mixture having a plurality of FS particles in a liquid component. FS particles and liquids may be any of those described above, for example. In this embodiment, the method comprises admixing a plurality of phage particles or binding portions thereof with the liquid component. The plurality of phage particles or binding portions thereof have binding domains selected to bind to the plurality of FS particles. Selection may vary, but generally includes exposing, in solution, a phage-display library to a binding target for a time period and recovering phage that bind to the binding target for use. Selection may be controlled so that the plurality of phage particles or binding portions thereof are selected to bind with at least one affinity chosen from low, mid and high. Phage that do bind, e.g. those having the desired affinity, may be replicated for use. Phage that do not bind may be removed prior to replication or use. Several replications and selection events may be performed, for example, to increase binding affinity. An exemplary selection is illustrated in Examples 1 and 2 below, however, these examples are clearly not intended to limit the scope of the invention.

The phage particles, or binding portions thereof, may be admixed at a variety of concentrations. For example, the phage particles or binding portions thereof may be added at a concentration chosen from about 0.01 to about 10 wt % of the plurality of FS particles.

Another exemplary embodiment includes a method for inhibiting the growth of an unwanted organism Inhibition includes suppression, and/or prevention, and/or any negative impact on pest fitness. The method includes administering a mixture of improved colloidal stability, such as any of the mixtures described above, to a medium containing the unwanted organism. The medium may be, for example, a plant or a part of a plant, such as at least one of seeds, seedlings, saplings, roots, tubers, stems, stalks, foliage and fruits. The unwanted organism may be a pest, such as at least one of a mite, an alga, a bird, a bacterium, a fungus, a weed, an insect, a mollusk, a nematode, a rodent, or a virus.

Another exemplary embodiment includes a storage and shipping system. The system includes a container having a capacity from about 0.1 L to about 160,000 L, and in additional embodiments from about 0.1 L to about 1000 L, and an aqueous mixture having improved colloidal stability located in the container. The aqueous mixture may include any described above, or other suitable mixtures.

Another exemplary embodiment includes a bio-additive for improving the colloidal stability of an aqueous mixture comprising a plurality of fine-solid (FS) particles. The bio-additive comprises a plurality of phage particles including a plurality of binding domains, or binding portions thereof, selected to bind to the active ingredient particles, for example, any of those described above.

### EXAMPLES

In order that those skilled in the art will be better able to practice embodiments of the invention, the following examples are given by way of illustration and not by way of limitation. In the following examples, as well as elsewhere in the specification and claims, temperatures are in degrees Celsius, and the pressure is atmospheric unless indicated otherwise.

### Example 1

### Bacteriophage Preparation

An M13 clone (STB1-P) derived from the NEB PhD C7C library (New England Biolabs, Ipswich, Mass., #E8120S) that expresses a g3P-displayed constrained heptapeptide with specificity for SiO2 particles (Chen et al. QCM-D Analysis of Binding Mechanism of Phage Particles Displaying a Constrained Heptapeptide with Specific Affinity to SiO2 and TiO2. Analytical Chemistry, 2006, vol. 78, p 4872-4879) was prepared for testing. In addition, a wild-type g3P M13 clone (M13K07; New England Biolabs #NO315S) was prepared. Preparation of pure bacteriophage samples followed methods known to those skilled in the art, for general reference see the New England Biolabs PhD C7C Phage Display Library Kit Instruction Manual (#E8120S).

50 ml of LB-tet in a 250 ml baffled flask was inoculated with 0.5 ml of an E. coli ER2738 (New England Biolabs, Ipswich, Mass., #E4104S) starter culture and incubated at 37 deg C., with shaking at 250 rpm for ca. 2.5 hrs until the OD600 reached 0.45. At this point the culture was split into two fresh 250 ml flasks (15 ml of culture in each) and each flask was then inoculated with 200 ul (ca. 2E10 pfu) of either STB1-P or M13K07 bacteriophage, and incubated at 37 deg C., with shaking at 250 rpm for 4.5 hrs. Then the cultures were centrifuged at 4600 rpm for 10 mins to pellet the cells, and the bacteriophage-containing supernatants were filtered using 0.45 um minisart units (Sartorius Stedim Biotech, Aubagne, France) prior to additions of 0.6 g PEG8000 and 0.45 g NaCl. The solids were dissolved and the samples were then incubated at 4 deg C. overnight to precipitate the bacteriophage. The samples were centrifuged at 10,000×g at 4 deg C. for 30 mins. The bacteriophage pellets were large and clearly visible. The pellets were re-suspended in 0.5 ml PBS and decanted into 1.5 ml eppendorf tubes and stored at 4 deg C. To further increase the amount of bacteriophage available for testing a larger-scale infection was then conducted.

A fresh ER2738 starter-culture was used to inoculate 750 ml LB-tet in a 2.51 baffled flask. After 2.5 hrs of incubation at 37 deg C., with shaking at 250 rpm, the OD600 was ca. 0.45. The culture was split to prepare two 200 ml cultures in 500 ml baffled flasks. 50 ul of each new bacteriophage sample was used to inoculate each flask. The cultures were incubated at 37 deg C., with shaking at 250 rpm overnight. The cultures were harvested by centrifugation at 3700 g for 10 mins and the supernatants were decanted to fresh 250 ml pots containing 8 g PEG8000 and 6 g NaCl. The solids were dissolved at 30 deg C., with shaking at 250 rpm, and then the samples were incubated on ice for 1.5 hr. The precipitated bacteriophage were collected by centrifugation at 10,000 rpm for 30 mins at 4 deg C. The pellets were re-suspended in 5 ml PBS and decanted to 15 ml Falcon tubes. They were then centrifuged at 4600 rpm for 20 mins to remove cell debris. The supernatants were aspirated and passed through 0.45 um minisart filters, to further purify the bacteriophage samples. The filtrates were collected in fresh tubes, and they appeared clear and somewhat viscous. Bacteriophage samples were stored at 4 deg C.

In order to titre the bacteriophage samples, the bacteriophage titre protocol described by New England Biolabs was followed. 1 ul of each new bacteriophage sample was used to create a dilution series in LB: 1E3; 1E6; 1E9; 1E10; 1E11. 10 ul of each dilution was used to inoculate 200 ul of ER2738 cells (OD600=0.45) in 1.5 ml eppendorf tubes at room temperature for 5 mins. After this incubation, the contents of the inoculation tube were mixed with molten Top Agarose at 45 deg C. and immediately poured onto the surface of an LB-Xgal/IPTG plate. Once cooled, the plates were inverted and incubated at 37 deg C. overnight. Titre plates were inspected the following day: only blue plaques were visible on STB1-P plates, only white plaques were visible on M13K07 plates—confirming the presence/absence of the lacZalpha marker gene, respectively.

The calculated titres were:
STB1-P=5E15 pfu.ml−1
M13K07=1.4E15 pfu.ml−1

The total volumes recovered were 3 mls in each case. Hence the yield of phage in terms of mass, assuming 1 ug of M13 is approx. equivalent to 3.76E10 pfu*, was:
STB1-P=(3 ml×5E15 pfu)/3.76E10 pfu=398.9 mg (or, 133 mg.ml−1)
M13K07=(3 ml×1.4 E15 pfu)/3.76 E10 pfu=112 mg (or, 32 mg.ml−1)
   *The approx. molecular mass of M13 is 16.3 MDa. The mass of 1 Da is 1.66053873E−24 g. Hence, one phage particle=2.656861968E−17 g. Thus, 1 ug of M13=3.76E10 particles (pfu).

### Example 2

### Bacteriophage Binding Density and Affinity

Samples of silica suspensions with bacteriophage bound to the surface were prepared as follows: Three 20 mL samples of a 1 wt % suspension of Sipernat™ S50 (Evonik Degussa, GmbH, Frankfurt, Germany) were prepared in PBS buffer with 0.1 wt % Tween® 20 (Croda, Plc, East Yorkshire, England) to aid dispersion. One 20 mg aliquot of bacteriophage suspension was added to each of the Sipernat™ S50 suspensions and these preparations were allowed to equilibrate overnight on a roller-bed. Unbound bacteriophage were washed from the samples by five successive washes (pellet by centrifugation, aspirate supernatant, add back 40 mL of PBS buffer, re-suspend by shaking) After the final supernatant aspiration, the volume was restored to the original 20 mL with PBS buffer, leaving a sample with essentially no unbound bacteriophage.

The bound bacteriophage were released from the silica surface as follows: A 1 mL aliquot of sample with no unbound bacteriophage as described above was pelleted by centrifugation, the supernatant was aspirated, the pellet was re-suspended in 0.66 mL of 100 mM Glycine (pH2.2) by vortex, then incubated for 10 minutes on a rotary mixer. These samples were centrifuged again and the supernatants, which now contained only the released bacteriophage, were collected by aspiration and transferred to sample tubes containing 0.33 mL 1M Tris buffer (pH 8.0) to neutralize.

The titre of the recovered bacteriophage in each sample was determined using the same method as described in Example 1.

| Bacteriophage clone | pfu/mL |
|---|---|
| STB1-P | 6.2E10 |
| M13K07 | 6.0E8 |

These values show that in 1 mL of a 1 wt % Sipernat™ S50 suspension, there were 6.2×10¹⁰ plaque forming units of bacteriophage clone STB1-P bound to the silica surface after successive washing, whereas there were only 6.0×10⁸ of clone M13K07. The secondary particle size of Sipernat™ S50 is stated to be median 8 μm by the manufacturer and the density of silica is approximately 2.4 g/mL, giving a specific surface area for Sipernat™ S50 of approximately 0.31 m²/g. Thus the approximate binding density of clone STB1-P on silica was 2.0×10¹³ pfu/m² whereas for clone M13K07 it was 1.9×10¹¹ pfu/m². This example illustrates that it is possible prepare bacteriophage samples that bind with high affinity to a particle surface such that the bacteriophage can remain bound to the surface even with stringent washing or dilution as would commonly occur in commercial use.

### Example 3

### Bacteriophage Dispersant Functionality

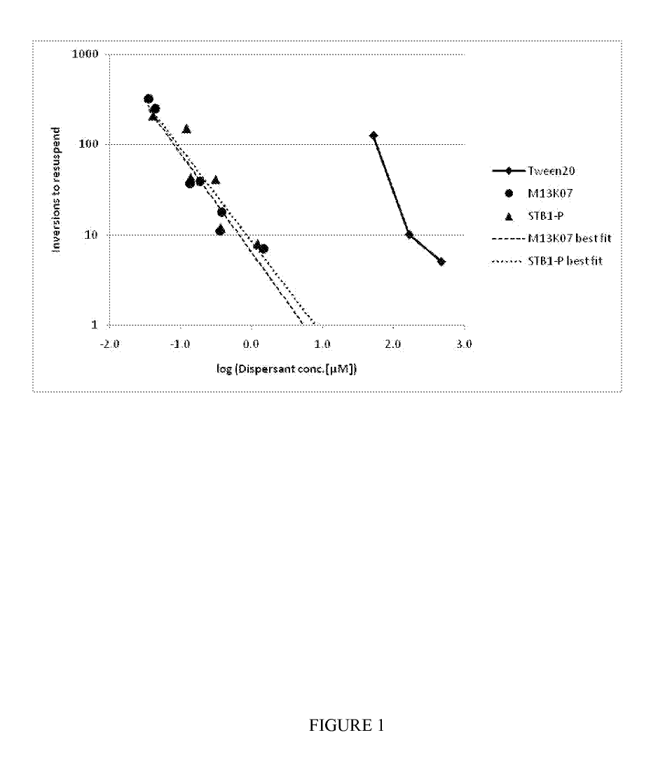

Suspensions of bacteriophage STB1-P and M13K07 in PBS buffer were prepared as described above. Sub-samples were dried overnight at 60° C. and the concentrations of bacteriophage were determined to be respectively 0.65 and 0.80 wt %. A stock solution of Tween® 20 was also prepared at 0.019 wt % in PBS. The molecular weight of Tween® 20 is approximately 1228. A silica suspension was prepared by diluting 2.0 g of Sipernat™ 22S (Evonik Degussa, GmbH, Frankfurt, Germany) to 100 g with PBS buffer, mixing with a rotor-stator mixer and sonicating for 10 mins. 13 g samples of 1 wt % silica suspension with various concentrations of bacteriophage or Tween® 20 were then prepared by combining the stock solutions, vortexing, sonication, and then placement on a shaker platform overnight. These samples were then allowed to settle overnight, and the number of inversions needed to completely re-suspend the sediment was recorded. The results are presented in FIG. 1 below. These results show that on a molecule-for-molecule basis, phage particles when bound to a particle surface can have greatly superior dispersant performance to a commercial standard such as Tween® 20. Even on a weight-for-weight basis the bacteriophage perform similarly to the commercial standard. These results further show, in combination with the example 2 above, that bacteriophage are able to remain bound to a particle surface and perform as dispersants under stringent dilution as would occur in commercial use, and such as would remove a conventional surfactant from the particle surface.

### Example 4

### Selection of Other Binding Domains

The identification and characterization of binding domains capable of binding to crystalline particles of an active ingredient may also be achieved using phage display of alternative polypeptide structures to that described in Example 1, for example, using protein structural domains that are capable of forming contacts with target surfaces to achieve affinity-interactions. Such protein structural domains may include FAb; Fv; scFv; stAb; dAb; V_{HH}; IgNAR; CDRs; DARPin ankyrin-repeat proteins; anti-calins; antibody-mimics, or fragments thereof. In addition, phage-display libraries may be created from naive or immune binding domain molecular repertoires. Naive repertoires may be generated from e.g. un-immunized animal B-lymphocyte mRNA and/or diversity-expanded DNA libraries through the use of PCR and degenerate oligonucleotides. Immune repertoires may be generated by first immunizing an animal with an appropriate formulation of crystalline particles, monitoring for an immune response and, if a response is evident, preparing B-lymphocyte mRNA from which PCR can be used to amplify the desired molecular repertoire for cloning into a bacteriophage-display library. The phage-display library may be incubated in solution with the target surface for a time period and target-specific bacteriophage particles may be selected by removing unbound bacteriophage (by solution exchange for example), and replicating those bacteriophage that have remained bound to the target. Target-specific bacteriophage can be DNA-sequenced to determine the exact nucleic acid code for the binding-domain, allowing further options for engineering/improvement of the binding-domain, or use independently of the bacteriophage itself. Alternative binding-domain display technologies, e.g. bacterial, yeast, ribosomal, may be employed in the selection of desired binding-domains.

### FORMULATION EXAMPLES FOR MIXTURES TO BE USED ACCORDING TO EXEMPLARY EMBODIMENTS OF THE DISCLOSURE (%=BY WEIGHT)

| Mixture | a) | b) | c) | d) | e) |
|---|---|---|---|---|---|
| FS particles | 3% | 10% | 25% | 50% | 40% |
| | azoxystrobin | thiamethoxam | atrazine | chlorothalonil | abamectin |
| Phage particles | 10% | 5% | — | — | 3% |
| (% of FS | | | | | |
| particle weight) | | | | | |
| Binding | — | — | 0.1% | 1% | 3% |
| portions thereof | | | | | |
| (% of FS | | | | | |
| particle weight) | | | | | |
| iso-tridecyl 6- | 1% | 1% | 1% | 1% | 1% |
| mole ethoxylate | | | | | |
| xanthan | 0.2% | 0.2% | 0.2% | 0.2% | 0.2% |
| Proxel GXL | 0.2% | 0.2% | 0.2% | 0.2% | 0.2% |
| Silicone oil | 0.1% | 0.1% | 0.1% | 0.1% | 0.1% |
| emulsion | | | | | |
| Water | 95.2% | 88% | 73.5% | 48% | 56.1% |

Numerous characteristics and advantages have been set forth in the foregoing description, together with details of structure and function. The disclosure, however, is illustrative only, and changes may be made in detail, especially in matters of shape, size, and arrangement of parts, within the principle of the invention, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety. It is further noted that, as used in this specification, the singular forms “a,” “an,” and “the” include plural referents unless expressly and unequivocally limited to one referent.

What is claimed is:

1. A colloidal mixture comprising:
a liquid component; and
a solid component dispersed in the liquid component, the solid component comprising
a plurality of fine-solid (FS) particles, and
a plurality of phage particles having binding domains, or binding portions thereof, selected to bind to the plurality of FS particles,
wherein the phage particles improve the colloidal stability of the mixture.

2. The mixture of claim 1, wherein the solid component concentration is chosen from about 0.1 to about 60 wt % of the mixture weight.

3. The mixture of claim 2, wherein the phage particle or binding portions thereof are present in a concentration chosen from about 0.01 to about 10 wt % of the plurality of FS particles.

4. The mixture of claim 1,
wherein the phage particles or binding portions thereof improve the colloidal stability of the mixture as measured by at least one assay chosen from Colloidal Stability Assay I, Colloidal Stability Assay II, Colloidal Stability Assay III, Colloidal Stability and Assay IV, and
wherein the at least one improvement includes at least one improvement chosen from greater than 5% improvement, greater than 10% improvement, greater than 15% improvement, greater than 20% improvement, greater than 30% improvement, and greater than 35% improvement.

5. The mixture of claim 1, wherein the plurality of FS particles includes particles of at least one pesticidal compound chosen from at least one of an acaricide, an algicide, an avicide, a bactericide, a fungicide, a herbicide, an insecticide, a molluscicide, a nematicide, a rodenticide, and a virucide.

6. The mixture of claim 5, wherein the at least one insecticide includes thiamethoxam.

7. The mixture of claim 1, wherein the FS particles have median diameter chosen from about 10⁻⁸ to about 10⁻⁴ m.

8. The mixture of claim 1, wherein the FS particles include crystalline particles.

9. The mixture of claim 1, wherein the plurality of binding domains are biologically-expressed as translational fusions with phage coat proteins.

10. The mixture of claim 1, wherein the plurality of phage particles include members of at least one morphological group chosen from icosahedral, complex and filamentous.

11. The mixture of claim 1, wherein the plurality of phage particles or binding portions thereof are selected to bind with at least one affinity chosen from low, mid and high.

12. A method for improving the colloidal stability of a colloidal mixture having a plurality of fine-solid (FS) particles in a liquid component, the method comprising:
admixing a plurality of phage particles or binding portions thereof with the liquid component, wherein the plurality of phage particles or binding portions thereof have binding domains selected to bind to the plurality of FS particles, and
wherein the phage particles are admixed at a concentration that improves the colloidal stability of the mixture.

13. The method of claim 12,
wherein the FS particles are present in a concentration chosen from about 0.1 to about 60 wt % of the mixture weight and
wherein the phage particles or binding portions thereof are added at a concentration chosen from about 0.01 to about 10 wt % of the plurality of FS particles.

14. The method of claim 12,
wherein the phage particles or binding portions thereof improve the colloidal stability of the mixture as measured by at least one assay chosen from Colloidal Stability Assay I, Colloidal Stability Assay II, Colloidal Stability Assay III, Colloidal Stability and Assay IV, and
wherein the at least one improvement includes at least one improvement chosen from greater than 5% improvement, greater than 10% improvement, greater than 15% improvement, greater than 20% improvement, greater than 30% improvement, and greater than 35% improvement.

15. The method of claim 12, wherein the plurality of phage particles or binding portions thereof are selected to bind with at least one affinity chosen from low, mid and high.

16. The method of claim 12, wherein phage particles are selected by
exposing, in solution, a phage-display library to a binding target for a time period,
removing unbound phage; and
replicating those phage which have bound to the binding target.

17. The method of claim 12, wherein the plurality of phage particles include members of at least one morphological group chosen from icosahedral, complex and filamentous.

18. The method of claim 12, wherein the plurality of FS particles includes particles of at least one pesticidal compound chosen from at least one of an acaricide, an algicide, an avicide, a bactericide, a fungicide, a herbicide, an insecticide, a molluscicide, a nematicide, a rodenticide, and a virucide.

19. The method of claim 12, wherein the FS particles a have median diameter chosen from about 10⁻⁸ to about 10⁻⁴ m.

20. The method of claim 12, wherein the FS particles include crystalline particles.

21. A bio-additive for improving the colloidal stability of an aqueous colloidal mixture comprising a plurality of fine-solid (FS) particles dispersed in a liquid component, the bio-additive comprising:
a plurality of phage particles including a plurality of binding domains, or binding portions thereof, selected to bind to the active ingredient particles.

22. A method for inhibiting the growth of an unwanted organism, the method comprising:
administering a mixture of improved colloidal stability to a medium containing the unwanted organism,
said mixture comprising a liquid component and a solid component dispersed in the liquid component, the solid component comprising
a plurality of fine-solid (FS) particles present in a biologically effective amount, and
a plurality of phage particles having binding domains, or binding portions thereof, selected to bind to the plurality of FS particles.

23. The method of claim 22,
wherein plurality of fine-solid particles are chosen from at least one of an acaricide, an algicide, an avicide, a bactericide, a fungicide, a herbicide, an insecticide, a molluscicide, a nematicide, a rodenticide, and a virucide, and
wherein the unwanted organism is chosen from at least one of a mite, an algae, a bird, a bacterium, a fungus, a weed, and insect, a mollusk, a nematode, a rodent, and a virus.

24. A storage and shipping system comprising:
a container having a capacity of about 0.1 L to about 160,000 L; and
an aqueous colloidal mixture having improved colloidal stability located in the container, the aqueous mixture comprising
about 0.1 to about 60 wt %, based on mixture weight, of a fine-solid (FS) particle, and
about 0.01 to about 10 wt %, based on FS particle weight, of phage particles having binding domains, or binding portions thereof, selected to bind to the plurality of FS particles.
